(19) United States
(12) Patent Application Publication
(10) Pub. No.: US 2009/0099963 A1
(43) Pub. Date: Apr. 16, 2009

(54) Tagged Products And Uses Thereof For After Point-Of-Sale Revenue Sharing

(75) Inventors: Blaine Mathieu, Dublin, CA (US); Malgosia Plucinska, Ottawa (CA)

Correspondence Address: HENSLEY KIM & HOLZER, LLC, 1660 LINCOLN STREET, SUITE 3000, DENVER, CO, 80264, US

(73) Assignee: COREL CORPORATION, Ottawa (CA)

(21) Appl. No.: 11/873,239

(22) Filed: Oct. 16, 2007

(51) Int. Cl. G06Q 40/00

(52) U.S. Cl. 705/39

(57) ABSTRACT

Methods are presented for providing after point-of-sale revenue sharing via tagged software. The methods provided allow for revenue sharing when products or services are provided in the future, or when products are upgraded in the future.

### BACKGROUND

Software applications and services are commonly distributed by bundling the applications in a hardware sale transacted by a hardware vendor, distributor, or reseller (collectively, “hardware vendor”) including direct sale computer vendors, brick-and-mortar retailers, their online counterparts, and OEM manufacturers and service providers. In the case of software applications being bundled with computer hardware, prior to delivery to the customer, the applications are installed on a storage device sold with the hardware (e.g., on the hard drive, on a CD-ROM, etc.). For example, a direct sale computer vendor, such as Dell Corporation, may bundle a variety of software applications into each computer unit sold, pre-installing the software for the customer. Some of these software applications may be complete, fully-operational versions of the software; others may be trial versions, with time-limited or feature-limited functionality; and others may merely be portals to online services (e.g., digital photo printing services), for which the customer is required to sign up for or pay for separately.

Currently, the hardware vendor, distributor, or reseller may or may not share revenue from the initial hardware sale with the independent software vendors having software applications in the bundle that accompanies the hardware unit. However, after the initial hardware sale, the software and service vendors can enjoy subsequent revenue from upgrades to the software or use of the services. For example a software vendor may not gain any revenue from the initial hardware sale with the bundled software application but the software vendor typically receives revenue when and if the customer upgrades from the trial version to the standard version or to some other upgraded version. Likewise, the service vendor may not gain any revenue from the initial hardware sale with a pre-installed portal to their service, but the service vendor typically receives revenue when and if the customer buys the service vendor's service through a software application on the hardware unit (e.g., purchase digital photo prints through the portal provided with the hardware unit).

### SUMMARY

Implementations described and claimed herein address the foregoing and other situations by providing after point-of-sale revenue sharing via tagged products such as software. The methods provided allow trackable revenue sharing for, e.g., an initial purchase of a hardware unit bundled with software products and/or services, such as online services, and for subsequent purchases of software products and/or services, including product upgrades, the unlocking of new features, using online services, etc.

The described technology provides in one implementation a method for providing after point-of-sale revenue sharing comprising: tagging a product with a distributor code associated with a distributor; associating the distributor code with a transaction by a user with a third-party provider resulting in revenue, where the transaction is conducted through the tagged product; and attributing a portion of the revenue generated by the transaction to the distributor associated with the distributor code on the tagged product. In some implementations of this method, the user is unaware of the tagging, associating and attributing steps. Also, in some implementations, the tagging, associating and attributing steps may be perpetuated into subsequently-installed products. In some implementations, the tagged product is software and the transaction may include without limitation an upgrade of the tagged software, procurement of another software unit, provision of services or a sale of goods.

Additional implementations of the technology provide methods for facilitating after point-of-sale revenue sharing comprising: contracting with a distributor who distributes tagged products; receiving notice of a third party providing a service or product accessed or executed through the tagged product in a transaction and of revenue received from the transaction; associating the revenue with the tagged product and distributor; and dispensing a portion of the revenue to the distributor according to the contract. In some implementations, the tagged product is software and the transaction may include without limitation an upgrade of the tagged software, procurement of another software unit, provision of services or a sale of goods.

Yet other implementations of the technology provide methods for facilitating after point-of-sale revenue sharing comprising: contracting with an entity to provide a tagged product to a user; contracting with a clearinghouse to receive a portion of revenue realized from products or services accessed through the tagged product; providing a tagged product to a user; and receiving revenue from a clearinghouse. In some implementations, the tagged product is software and the transaction may include without limitation an upgrade of the tagged software, procurement of another software unit, provision of services or a sale of goods. In some implementations, the entity is the clearinghouse, in other implementations the entity is a third party vendor, such as a software provider.

Additional implementations of the technology provide methods for facilitating after point-of-sale revenue sharing comprising: contracting with a clearinghouse to provide revenue received for a product or service provided through a tagged product; contracting with an entity to have the product or service accessible through the tagged product; receiving revenue from a user for providing the product or service accessed or executed through the tagged product; and providing a portion of revenue received from providing the product or service to the clearinghouse. In some implementations, the tagged product is software and the transaction may include without limitation an upgrade of the tagged software, procurement of another software unit, provision of services or a sale of goods.

Yet other implementations of the technology provide tagged software products having a distributor code associated with a distributor, where revenue resulting from a transaction by a user with a third party provider executed through the tagged software is associated with the distributor resulting in a portion of the revenue being dispensed to the distributor. In some implementations, the tagged software is associated with the distributor and revenue is dispensed to the distributor without input from the user. In some implementations, the transaction may include without limitation an upgrade of the tagged software, procurement of another software unit, provision of services or a sale of goods.

Additional implementations of the technology provide a computer-readable storage medium encoding a computer program for executing a computer process on a computer system, the computer process comprising: tagging a product with a distributor code associated with a distributor; associating the distributor code with a transaction by a user with a third-party provider resulting in revenue, the transaction being executed through the tagged product; and attributing a portion of the revenue generated by the transaction to the distributor associated with the distributor code.

This Summary is provided to introduce a selection of concepts in a simplified form that are further described below in the Detailed Description. This Summary is not intended to identify key or essential features of the claimed subject matter, nor is it intended to be used to limit the scope of the claimed subject matter. Other features, details, utilities, and advantages of the claimed subject matter will be apparent from the following more particular written Detailed Description of various embodiments and implementations as further illustrated in the accompanying drawings and defined in the appended claims.

### BRIEF DESCRIPTIONS OF THE DRAWINGS

FIG. 1 is a simplified diagram showing the various parties and transactions that may be involved in some implementations of the present technology.

FIG. 2 is a diagram showing in more detail the various parties and transactions that may be involved in some implementations of the present technology.

FIG. 3 is a flow chart showing the operations of one implementation of a method of the present technology.

FIG. 4 is a flow chart showing the operations of another implementation of a method of the present technology from the point of view of a clearinghouse.

FIG. 5 is a flow chart showing the operations of another implementation of a method of the present technology from the point of view of a distributor.

FIG. 6 is a flow chart showing the operations of another implementation of a method of the present technology from the point of view of a third party provider.

FIG. 7 is an exemplary computer system useful in some implementations of the technology where the tagged product is software.

### DETAILED DESCRIPTION

Technology is described herein for providing after point-of-sale revenue sharing via tagged products such as software. The methods provided in some implementations allow for revenue sharing for an initial purchase or unlock of products or services, but also provide revenue sharing for future product upgrades and/or purchases of related products or services as well.

In one implementation of the technology, software is manufactured and/or provided by X to Y, a hardware vendor, for Y to load onto the personal computers Y sells to users in the retail market such that the users may try the software. The software provided by X is tagged (i.e., the software comprises a vendor code) that associates the specific copy of the software with both X and Y at the time of the sale and into the future. For example, X may provide the software to Y in the form of a golden disk or via the internet Y's customer then uses X's tagged software for a period of time and opts to purchase an upgrade to the software at a future date.

Z, a third party product provider, sells upgrades to X's software. Z is unrelated to X and Y for the purposes of this implementation, but does not necessarily need to be unrelated to X or Y. When a user purchases an upgrade to X's software from Z, Z is made aware of the vendor code via the tagged software and associates the purchase of the upgrade and the resulting revenue with the vendor code. Z has contracted with a Clearinghouse to provide information on upgrade transactions involving tagged software, where Z provides the Clearinghouse information including that revenue was realized in an upgrade transaction (and, in some implementations, how much revenue was realized in the transaction) and the vendor code. Clearinghouse then determines which distributor is associated with the vendor code—in this case, Y—and the portion of revenue that should be passed on to Y. The portion of revenue may be a percentage of the amount Z received in the transaction, or may be a flat fee based on the transaction (allowing Z to maintain its pricing information as proprietary, for example).

Thus, the vendor code encoded by the tagged software enables Y, the hardware vendor or distributor, to share in downstream upgrades associated with the life of the tagged software manufactured and/or provided by X and initially distributed by Y, even when such upgrades are not directly driven by Y. This provides a revenue stream upside to a distributor such as Y, such that Y has an incentive to provide and promote X's software. In some implementations, X, the software provider, receives a portion of Z's revenue realized from the upgrade from Z directly, for manufacturing and providing the upgrade (that is, Z buys the upgrade version wholesale from X); or, in an alternative implementation, X also contracts with the Clearinghouse so that Z can send a portion of revenue realized to the Clearinghouse to pass on to both X, the software provider (but perhaps not the upgrade provider), and Y, the hardware vendor or distributor.

In addition, the method encompassed by this implementation and other implementations of the technology allow for the revenue reporting and sharing to take place without input from the user, and in some implementations, without knowledge of the user. Similarly, Z may or may not be aware of Y and of Y's receiving a portion of the revenue Z passes on to the Clearinghouse. Also, the same methodology described above for a first upgrade of the tagged software may be applied to future upgrades; that is, Y may still receive a revenue stream from any number of future upgrades though such upgrades are attenuated from Y's initial distribution of the tagged software, as the vendor code may be perpetuated through the upgrades of the tagged software.

In yet another implementation, software is manufactured and/or provided by X, a software provider, to Y, a hardware vendor or distributor, for Y to load onto the personal computers Y sells to users in the retail market such that the users may try the software (a trial version of the software) or as a basic or standard application for the personal computer. As in the example above, the software provided by X is tagged (i.e., the software comprises a vendor code) that associates the specific copy of the software with both X, the software provider, and Y, the hardware vendor or distributor, at the time of the sale and into the future. For example, the software may be provided in the form of a golden disk or via the internet.

The software has applications that allow access to Z's products and services. When the user accesses Z's product or services through the software, Z receives notice of the vendor code through the tagged software and associates any transaction purchasing goods or services and the resulting revenue with the vendor code. Z has contracted with Clearinghouse to provide information on transactions involving tagged software, where Z provides Clearinghouse information including that revenue was realized in a transaction (and, in some implementations, how much revenue was realized in the transaction) and the tag code. Clearinghouse then determines which distributor is associated with the vendor code—in this case, Y—and the portion of revenue that should be passed on to Y. Again, as before, the portion of revenue may be a percentage of the amount Z received in the transaction, or may be a flat fee based on the transaction (allowing Z to maintain its pricing information as proprietary, for example).

Thus, the tag enables Y, the hardware vendor or distributor, to share in future revenue streams associated with the life of the tagged software provided by X and initially distributed by Y, even when such revenue streams are not directly driven by Y. This provides a revenue stream upside to a distributor such as Y, such that Y has an incentive to provide and promote X's software. In some implementations, X receives a portion of Z's revenue from Z directly, for manufacturing the software that allows access to Z's products and services. In an alternative implementation, X also contracts with the Clearinghouse so that Z can send the portions of revenue owed to both X and Y for distribution. In addition, the method encompassed by this implementation and other implementations of the technology allow for the revenue reporting and sharing to take place without input from the user, and in some implementations, without knowledge of the user. Similarly, Z may or may not be aware of Y and of Y's receiving a portion of the revenue Z passes on to the Clearinghouse. Also, the same methodology described above for a first upgrade of the tagged software may be applied to future upgrades; that is, Y may still receive a revenue stream from any number of future upgrades though such upgrades are attenuated from Y's initial distribution of the tagged software, as the vendor code may be perpetuated through the upgrades of tagged software.

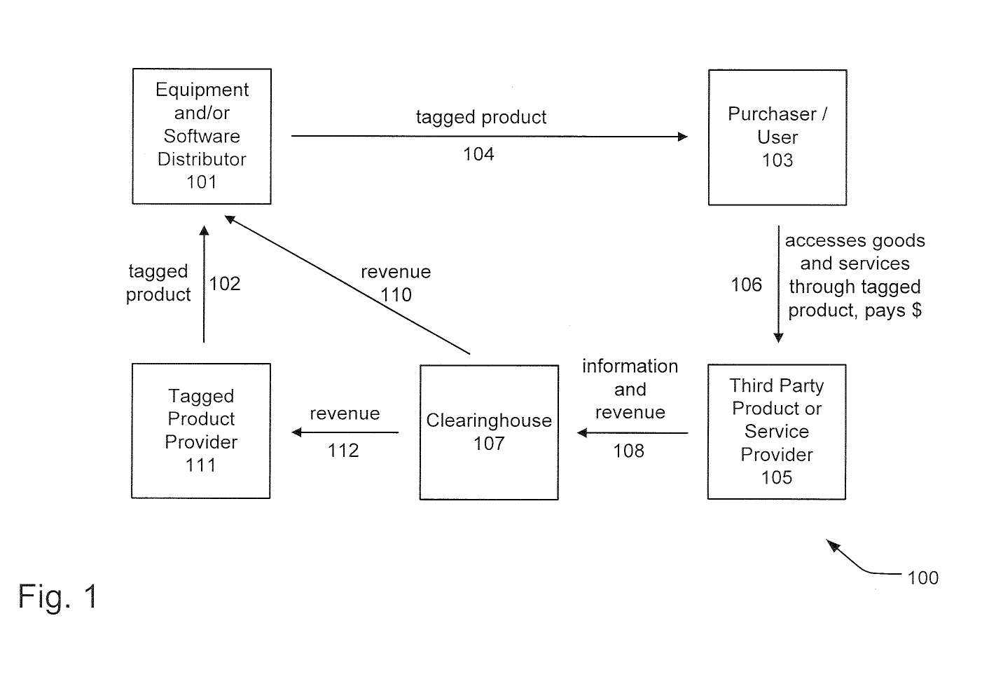

FIG. 1 is a simplified diagram showing the various parties and transactions that may be involved in providing both point-of-sale and after point-of-sale revenue sharing via tagged software. FIG. 1 shows a system 100 where an equipment and/or software distributor (entity 101), such as CVS, Dell, Apple, Best Buy, Circuit City, Amazon.com, CDW, Yahoo, Target and the like receives a tagged product (transaction 102) through a tagged product provider (entity 111) such as Corel, Microsoft, Adobe, Apple, Google and the like where distributor (entity 101) provides the tagged product (transaction 104) to a purchaser or user (entity 103) such as an individual or corporate entity user. The user accesses goods and services through the tagged product or upgrades the tagged product that in turn generates revenue (transaction 106) for a third party product or service provider (entity 105). The tagged product facilitates the purchase of the service or product or the upgrade by providing a user interface such as a portal, webpage, form or email with an embedded tag through which the transaction may be executed. The purchased products or services can be of any type, such as for example, retail goods such as clothing, electronics, books, DVDs and other media goods, computer software and hardware, housewares, furniture, appliances, food, pharmaceuticals, beauty supplies, nutraceuticals, animals (livestock or pets), or vehicles and the like; and services such as mortgage services, travel services, loan services, consulting services, investment and other financial services, tax preparation services, website construction services, car rental, photo printing or alteration services and the like.

The third party product or service provider (entity 105) can be any entity—brick and mortar establishments, online vendors, the originator of the software (that is, the tagged product provider such that entities 105 and 111 are the same entity) and the like though is it envisioned that online vendors and service providers are the most likely third party product or service providers—who provides products or services through a transaction related to the tagged product. The third party product or service provider (entity 105) then in turn passes a portion of the revenue earned from the purchase transaction (transaction 108) to a clearinghouse (entity 107). The clearinghouse is an entity with a database that can associate the purchase transaction (transaction 108) with the equipment and/or software distributor (entity 101) (and, in some implementations, the tagged product provider (entity 111)), and that can pass an appropriate portion of the revenue received by the third party product or service provider (entity 105) on (transaction 110) to the equipment and/or software distributor (entity 101) (and, in some implementations, on (transaction 112) to the tagged product provider (entity 111)). The clearinghouse (entity 107) may be, for example, an entity that simply receives revenue and information and passes an appropriate amount of revenue on to the distributor (entity 101), or the clearinghouse may be the source of the tagged software in addition to taking care of the revenue receiving and distributing functions (that is, entities 107 and 111 are the same entity). Also, though the tagged product has been described herein as software, in other implementations the tagged product may be tagged hardware; that is, the vendor code is hardwired into the computer hardware.

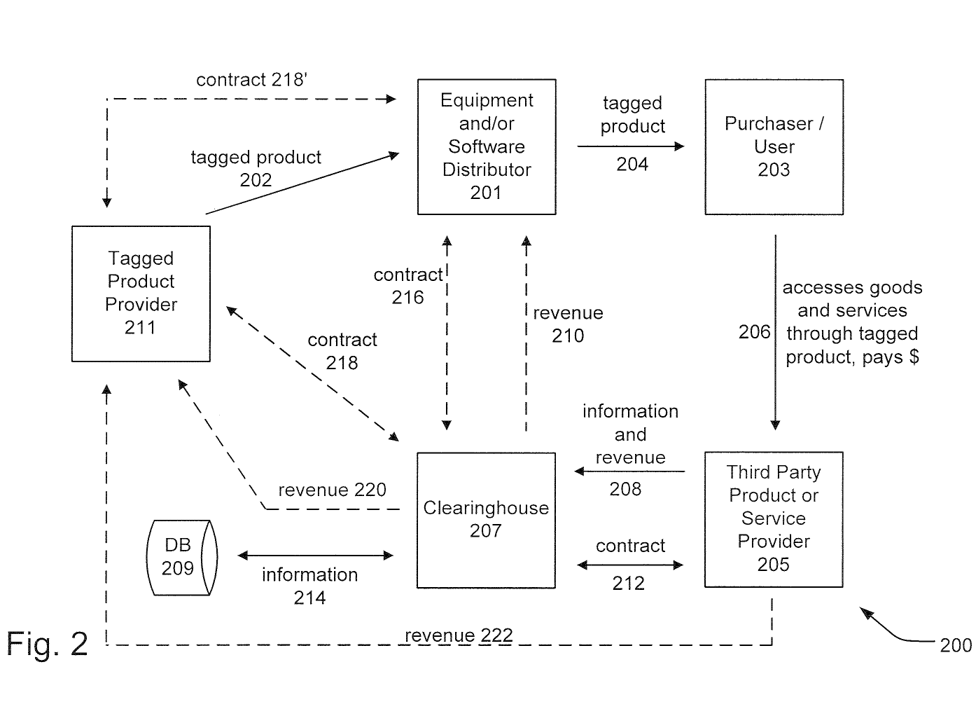

FIG. 2 is a diagram showing more detail than FIG. 1 of the various parties and transactions that may be involved in providing both point-of-sale and after point-of-sale revenue sharing via tagged software. FIG. 2 shows a system 200 where an equipment and software distributor (entity 201), again, such as CVS, Dell, Apple, Best Buy, Circuit City, Amazon.com, CDW, Yahoo, Target and the like receives a tagged product (transaction 202) from a tagged product provider (entity 211) such as Corel, Microsoft, Adobe, Apple, Google and the like. Equipment and software distributor (entity 201) then provides the tagged product (transaction 204) to a purchaser or user (entity 203) such as an individual or corporate entity user, where the user uses the tagged product to purchase a service or product or upgrades the tagged product that in turn generates revenue (transaction 206) for a third party product or service provider (entity 205). The tagged product facilitates the purchase of the service or product or the upgrade by providing a user interface such as a portal, webpage, form or email with an embedded tag through which the transaction may be executed. As noted above, the purchased products or services can be literally of any type.

The third party product or service provider (entity 205) then passes information about the transaction as well as a portion of the revenue earned from the purchase transaction (transaction 208) to a clearinghouse (entity 207), as required by a contract (transaction 212) between the third party product or service provider (entity 205) and the clearinghouse (entity 207). The clearinghouse (entity 207) is an entity with a database (209) that has information (214) to allow the clearinghouse (entity 207) to associate the purchase transaction (transaction 208) with the equipment and/or software distributor (entity 201). The clearinghouse (entity 207) then passes an appropriate portion of the revenue received by the third party product or service provider (entity 205) on (transaction 210) to the equipment and/or software distributor (entity 201) by virtue of a contract or agreement (transaction 216) between the clearinghouse (entity 207) and the equipment and/or software distributor (entity 201). Alternatively, the clearinghouse (entity 207) may contract (transaction 218′) with the tagged product provider (entity 211) and the tagged product provider (entity 211) may contract (transaction 218) with the equipment and/or software distributor (entity 201) to provide an agreed revenue sharing plan which is implemented by the clearinghouse (entity 207).

It should be noted that there may be any number and combination of contractual relationships for providing revenue. For example, there may be a contractual relationship between the third party provider and both the clearinghouse and the tagged product provider, or the third party provider may only provide revenue to the clearinghouse, wherein the clearinghouse then passes revenue on to both the equipment and software distributor and the tagged product provider. This is reflected in FIG. 2 where the revenue stream to the tagged product provider can come from the third party product or service provider (transaction 222) or from the clearinghouse (transaction 220). In yet another implementation, the clearinghouse may provide the revenue to the tagged product provider who passes on a portion to the equipment and software distributor (as opposed to the clearinghouse passing the revenue on to the equipment and software distributor). Similarly, the contractual relationships can vary as to which party provides the tagged product to the equipment and software distributor. In some instances it may be the clearinghouse, and in other instances the clearinghouse may not be related to the tagged product provider.

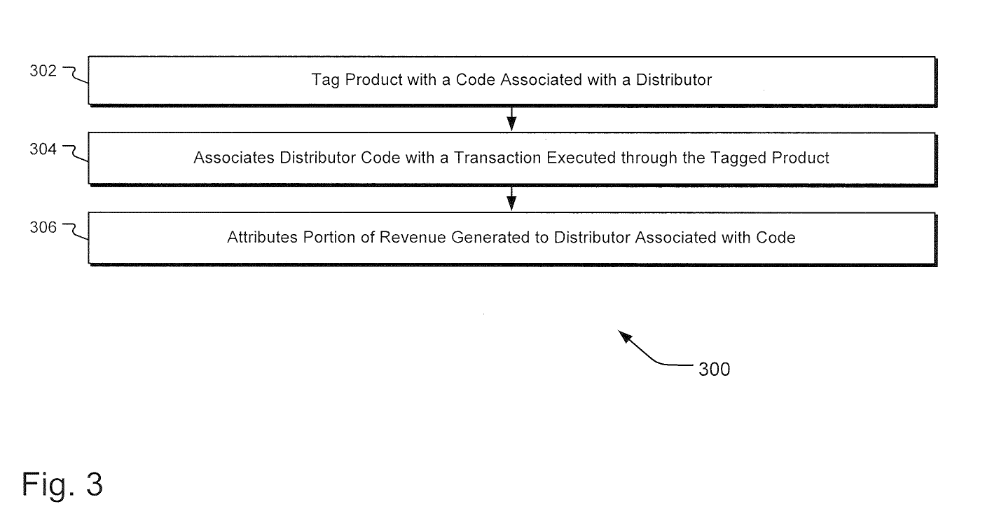

FIG. 3 is a flow diagram showing the operations of one implementation of a method 300 of the present technology. In a tagging operation (302), a product is tagged with a code associated with a distributor, such as CVS, Dell, Apple, Best Buy, Circuit City, Amazon.com, CDW, Yahoo, Target and the like. In one implementation, the software manufacturer creates a unique code for each combination of product and distributor. This code is then included as part of the software application's files that are installed on whatever device the software is installed on. The code is then readable by the original software application as well as by future applications and/or web services that know where to retrieve it from the software. The tagged software is then transmitted to the equipment and/or software distributor to be part of the bundled software on the hardware that is sold to a user. In an associating operation (304), the distributor or vendor code is associated with a transaction resulting in revenue involving a user of the tagged product and a third party provider of a product or service (such as Amazon.com, Shutterfly, Best Buy, Pottery Barn, H&R Block, Charles Schwab, Wells Fargo, Budget Rent-a-Car, Southwest Airlines, Westin Hotels, and virtually any other provider of products or services). In the associating operation (304), the distributor or vendor code is pushed out to the service provider via the tagged software, alternatively the third party's software/web service would know where to “look” for the code in the tagged software and would retrieve it. In other implementations, the distributor or vendor code is associated with a transaction where an order is printed out and the print out would include the distributor or vendor code, or the software application could direct the user to call in the order and provide a specific identifier number to the call center. In any of these implementations, the distributor or vendor code may then be associated with the transaction. In an attribution operation (306), a portion of the revenue generated by the transaction is attributed to the distributor associated with the code.

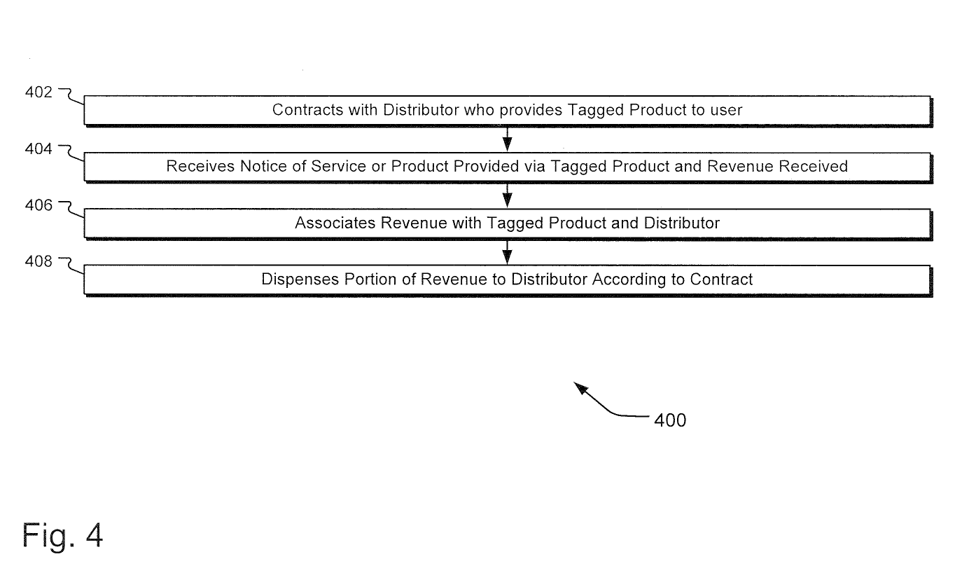

FIG. 4 is a flow chart showing the operations of another implementation of a method of the present technology from the point of view of a clearinghouse-type entity. In a contracting operation (402), the clearinghouse contracts with a distributor such as a hardware vendor who provides tagged software, agreeing to provide a portion of revenue the clearinghouse receives from a third party provider of goods and services if the tagged software is used to procure the goods and services. Next, in a notice operation (404), the clearinghouse receives notice of a service or product supplied by the third party provider via the tagged product, or of an upgrade to the software provided by the third party provider where revenue was received by the third party provider. The clearinghouse then, in an associating operation (406), associates the revenue received by the third party provider with the tagged software and the distributor and dispenses a portion of the revenue received on to the distributor according to the contract between the clearinghouse and the distributor (408). Not shown in FIG. 4 but in what would be an alternative implementation, the clearinghouse entity contracts with the tagged product provider where the clearinghouse provides a portion of the revenue received to the tagged product provider, who in turn provides the portion of the revenue to the distributor. In yet another embodiment, the clearinghouse may be the tagged product provider; that is, the tagged product provider may itself be the entity that receives notice of the service or product provided via the tagged product, associates revenue with the tagged product and distributor and dispenses a portion of the revenue to the distributor.

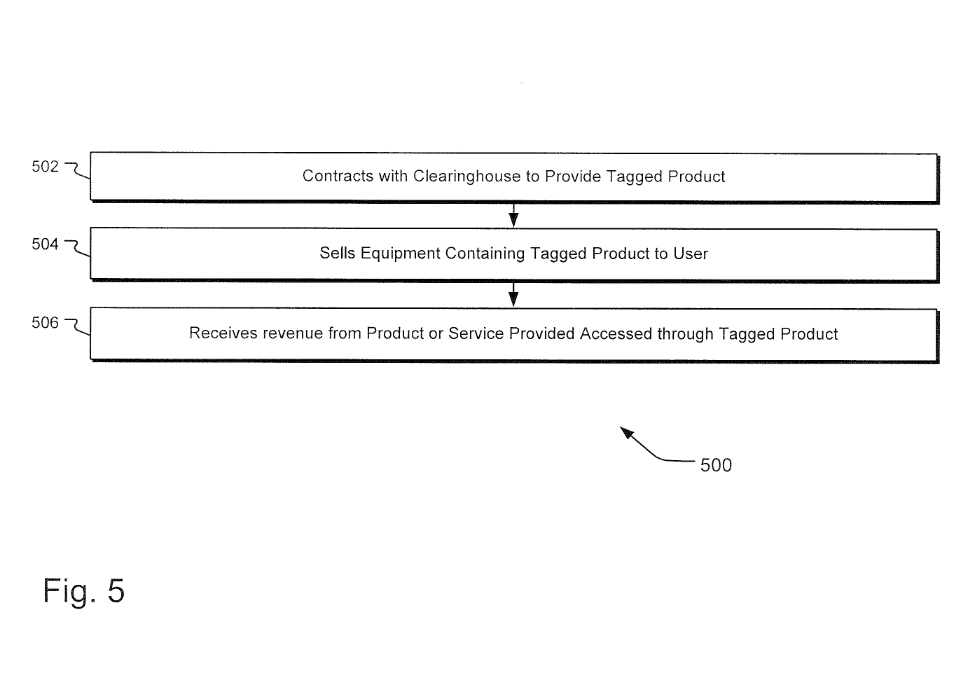

FIG. 5 is a flow chart showing the operations of another implementation of a method of the present technology from the point of view of a distributor such as a hardware vendor. In a contracting operation (502) of this method, the distributor contracts with a clearinghouse to provide tagged product(s) with equipment or other goods distributed by the distributor. In distributing operation (504), the distributor distributes the equipment or other goods to a user. By distribute, it is meant that the equipment or other goods are sold, leased, provided free of charge or otherwise provided by the distributor. In a receiving operation (506), the distributor receives revenue from the clearinghouse, who received revenue from a third party provider of products or services where the product or service was executed or accessed through the tagged product.

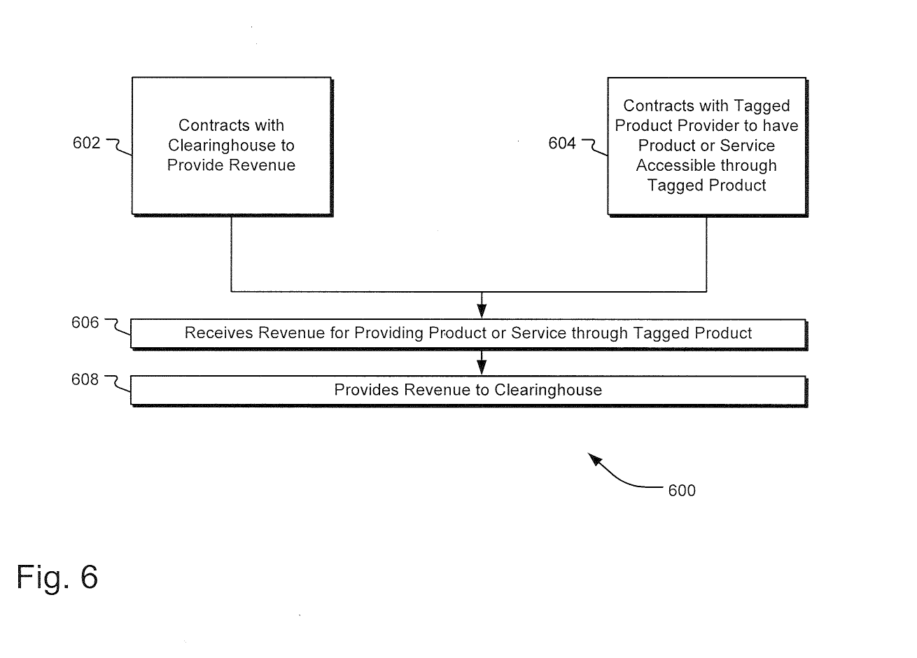

FIG. 6 is a flow chart showing the operations of another implementation of a method of the present technology from the point of view of a third party provider. In a contracting operation of this method (602), the third party provider contracts with a clearinghouse to provide revenue the third party provider receives from the sale of products or provision of services that were executed, provided or accessed through a tagged product to the clearinghouse. In another contracting operation (604), the third party provider also contracts with a tagged product provider to have a product or service accessible through the tagged product. In a receiving operation (606), the third party provider receives revenue for providing a product or service through the tagged product and then in a providing operation (608) provides a portion of the revenue received to the clearinghouse under the terms of the contracts made in steps 602 and 604. The entity that contracts with the third party to make the product or service accessible through the tagged product may be an entity other than a software manufacturer. For example, the tagged product provider may be the clearinghouse.

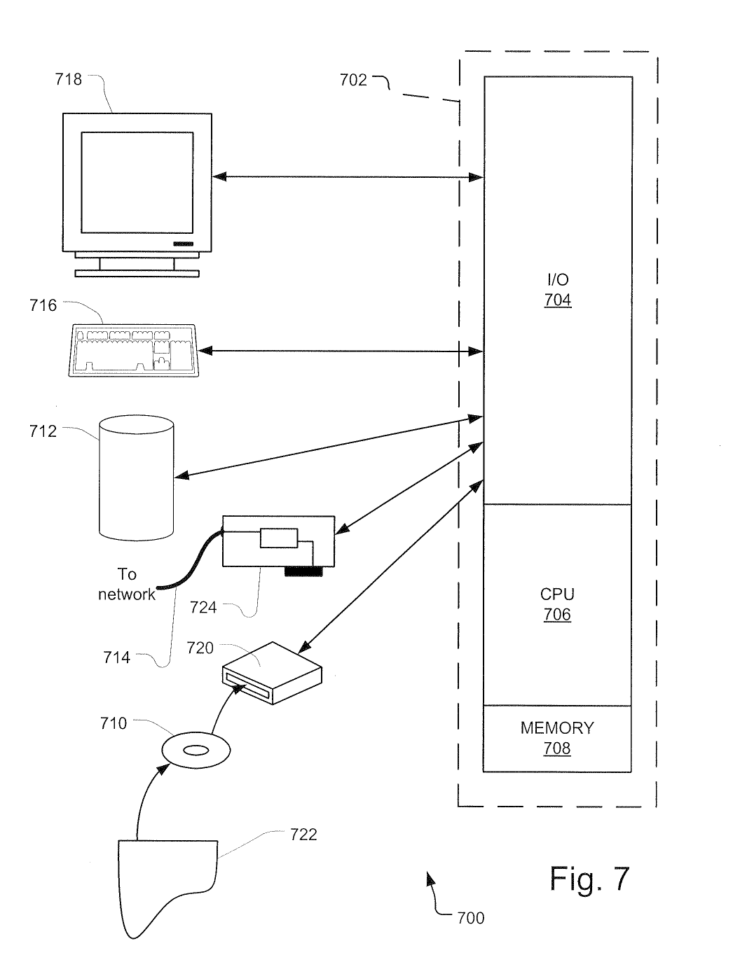

FIG. 7 illustrates an example computing system that can be used to implement the described technology. A general purpose computer system 700 is capable of executing a computer program product to execute a computer process. Data and program files may be input to the computer system 700, which reads the files and executes the programs therein. Some of the elements of a general purpose computer system 700 are shown in FIG. 7 wherein a processor 702 is shown having an input/output (I/O) section 704, a Central Processing Unit (CPU) 706, and a memory section 708. There may be one or more processors 702, such that the processor 702 of the computer system 700 comprises a single central-processing unit 706, or a plurality of processing units, commonly referred to as a parallel processing environment. The computer system 700 may be a conventional computer, a distributed computer, or any other type of computer. The described technology is optionally implemented in software devices loaded in memory 708, stored on a configured DVD/CD-ROM 710 or storage unit 712, and/or communicated via a wired or wireless network link 714 on a carrier signal, thereby transforming the computer system 700 in FIG. 7 to a special purpose machine for implementing the described operations.

The I/O section 704 is connected to one or more user-interface devices (e.g., a keyboard 716 and a display unit 718), a disk storage unit 712, and a disk drive unit 720. Generally, in contemporary systems, the disk drive unit 720 is a DVD/CD-ROM drive unit capable of reading the DVD/CD-ROM medium 710, which typically contains programs and data 722. Computer program products containing mechanisms to effectuate the systems and methods in accordance with the described technology may reside in the memory section 704, on a disk storage unit 712, or on the DVD/CD-ROM medium 710 of such a system 700. Alternatively, a disk drive unit 720 may be replaced or supplemented by a floppy drive unit, a tape drive unit, or other storage medium drive unit. The network adapter 724 is capable of connecting the computer system to a network via the network link 714, through which the computer system can receive instructions and data embodied in a carrier wave. Examples of such systems include Intel and PowerPC systems offered by Apple Computer, Inc., personal computers offered by Dell Corporation and by other manufacturers of Intel-compatible personal computers, AMD-based computing systems and other systems running a Windows-based, UNIX-based or other operating system. It should be understood that computing systems may also embody devices such as Personal Digital Assistants (PDAs), mobile phones, gaming consoles, set top boxes, etc.

When used in a LAN-networking environment, the computer system 700 is connected (by wired connection or wirelessly) to a local network through the network interface or adapter 724, which is one type of communications device. When used in a WAN-networking environment, the computer system 700 typically includes a modem, a network adapter, or any other type of communications device for establishing communications over the wide area network. In a networked environment, program modules depicted relative to the computer system 700 or portions thereof, may be stored in a remote memory storage device. It is appreciated that the network connections shown are exemplary and other means of and communications devices for establishing a communications link between the computers may be used.

In an exemplary implementation, a tagging module, an associating module, an attributing module and other modules may be incorporated as part of the operating system, application programs, or other program modules. Vendor codes, codes for associating and perpetuating the vendor codes, and other data may be stored as program data in memory 708 or other storage systems, such as disk storage unit 712 or DVD/CD-ROM medium 710.

The present specification provides a complete description of the methodologies, systems and/or structures and uses thereof in example implementations of the presently-described technology. Although various implementations of this technology have been described above with a certain degree of particularity, or with reference to one or more individual implementations, those skilled in the art could make numerous alterations to the disclosed implementations without departing from the spirit or scope of the technology hereof. Since many implementations can be made without departing from the spirit and scope of the presently described technology, the appropriate scope resides in the claims hereinafter appended. Other implementations are therefore contemplated. Furthermore, it should be understood that any operations may be performed in any order, unless explicitly claimed otherwise or a specific order is inherently necessitated by the claim language. It is intended that all matter contained in the above description and shown in the accompanying drawings shall be interpreted as illustrative only of particular implementations and are not limiting to the embodiments shown. Changes in detail or structure may be made without departing from the basic elements of the present technology as defined in the following claims.

1. A method for providing after point-of-sale revenue sharing comprising:
tagging a product with a distributor code associated with a distributor;
associating the distributor code with a transaction by a user with a third-party provider resulting in revenue, the transaction being executed through the tagged product; and
attributing a portion of the revenue generated by the transaction to the distributor associated with the distributor code.

2. The method according to claim 1 wherein the user is unaware of the tagging, associated and attributing steps.

3. The method according to claim 1 wherein subsequently-installed products perpetuate the tagging, associating and attributing steps.

4. The method according to claim 1 wherein the tagged product is software.

5. The method according to claim 4 wherein the tagged product is software and the transaction is an upgrade.

6. The method according to claim 1 wherein the transaction is a sale of goods or a provision of services.

7. A method for facilitating after point-of-sale revenue sharing comprising:
contracting with a distributor who provides tagged products;
receiving notice of a third party providing a service or product accessed through the tagged product in a transaction;
receiving revenue from the transaction;
associating the revenue with the tagged product and distributor; and
dispensing a portion of the revenue to the distributor according to the contract.

8. The method according to claim 7 wherein the tagged product is software and the transaction is an upgrade, a sale of goods or a provision of services.

9. The method according to claim 7 wherein the distributor receives the tagged product from a vendor entity, and a portion of the revenue is dispensed to the vendor entity.

10. A method for facilitating after point-of-sale revenue sharing comprising:
contracting with an entity to provide a tagged product to a user;
contracting with a clearinghouse to receive a portion of revenue received from revenue realized from products or services accessed through the tagged product;
providing a tagged product to a user; and
receiving revenue from the clearinghouse.

11. The method according to claim 10 wherein the tagged product is software and the product or service is a software upgrade, a sale of goods or a provision of services.

12. The method according to claim 10 wherein the tagged product is software and the product or service is sale of goods.

13. The method according to claim 10 wherein the entity contracts with the clearinghouse and receives a portion of the revenue received from revenue realized from products or services accessed through the tagged products.

14. A method for facilitating after point-of-sale revenue sharing comprising:
contracting with a clearinghouse to provide revenue received for a product or service accessed through a tagged product;
contracting with an entity to have the product or service accessible through the tagged product;
receiving revenue from a user for providing the product or service accessed through the tagged product; and
providing a portion of revenue received from providing the product or service to the user to the clearinghouse.

15. The method according to claim 14 wherein the tagged product is software and the product or service is a software upgrade, a sale of goods or the provision of services.

16. The method according to claim 14 wherein the entity is the clearinghouse.

17. The method according to claim 14, wherein the entity is a third party entity wherein the third party entity receives a portion of the revenue.

18. A tagged software product having a distributor code associated with a distributor, where revenue resulting from a transaction by a user with a third party provider executed through the tagged software is associated with the distributor resulting in a portion of revenue being dispensed to the distributor.

19. The tagged software product of claim 18, wherein the tagged software is associated with the distributor and revenue is dispensed to the distributor without input from the user.

20. A computer-readable storage medium encoding a computer program for executing a computer process on a computer system, the computer process comprising:
tagging a product with a distributor code associated with a distributor;
associating the distributor code with a transaction by a user with a third-party provider resulting in revenue, the transaction being executed through the tagged product; and
attributing a portion of the revenue generated by the transaction to the distributor associated with the distributor code.
